(19) United States
(12) Patent Application Publication
(10) Pub. No.: US 2025/0351011 A1
(43) Pub. Date: Nov. 13, 2025

(54) EVOLVED PACKET SYSTEM FALLBACK FOR LOCATION SERVICES

(71) Applicant: Cisco Technology, Inc., San Jose, CA (US)

(72) Inventors: Vimal Srivastava, Bangalore (IN); Srinath Gundavelli, San Jose, CA (US)

(21) Appl. No.: 18/657,125

(22) Filed: May 7, 2024

(51) Int. Cl. H04W 36/00; H04W 36/16

(52) U.S. Cl. CPC H04W 36/00222; H04W 36/16

(57) ABSTRACT

A method, computer system, and computer program product are provided for performing evolved packet system fallback for location services. A request is received from a location service client for a location of a user equipment that is connected to a first network. In response to determining that the first network does not support location services, a fallback of the user equipment to a second network is triggered. A location of the user equipment is obtained using the second network. The location of the user equipment is provided to the location service client.

### TECHNICAL FIELD

The present disclosure relates generally to network equipment and services.

### BACKGROUND

Networking architectures have grown increasingly complex in communications environments, particularly wireless networking environments. For example, mobile communication networks have grown substantially as end users become increasingly connected to mobile network environments. In some instances, it may be desirable to facilitate location services for wireless devices in Third Generation Partnership Project (3GPP) wireless networks, such as 3GPP Fifth Generation (5G) wireless networks. However, many network operators have not deployed network elements that support 5G location services; thus, there can be significant challenges with regard to providing location services for wireless devices in some 5G network scenarios.

### BRIEF DESCRIPTION OF THE DRAWINGS

FIG. 1 is a block diagram depicting an environment for performing evolved packet system (EPS) fallback to support location services, according to an example embodiment.

FIGS. 2A and 2B are a signaling flow diagram depicting a method for supporting location services using EPS fallback, according to an example embodiment.

FIG. 3 is a flow chart depicting a method for supporting location services using EPS fallback, according to an example embodiment.

FIG. 4 is a block diagram depicting a computing device, according to an example embodiment.

### DETAILED DESCRIPTION

### Overview

According to one embodiment, techniques are provided for performing evolved packet system fallback for location services. A request is received from a location service client for a location of a user equipment that is connected to a first network. In response to determining that the first network does not support location services, a fallback of the user equipment to a second network is triggered. A location of the user equipment is obtained using the second network. The location of the user equipment is provided to the location service client.

### Example Embodiments

A Location Management Function (LMF) is a key component in the Third Generation Partnership Project (3GPP) fifth generation (5G) positioning architecture. The LMF is responsible for managing and tracking the location of user equipment (UEs) within a network. The LMF keeps track of each UE's current location and updates this information as the UE moves. The LMF may receive measurements and assistance information from both the radio access network (RAN) and UEs through an Access and Mobility Function (AMF) and can compute the position of UEs over an interface such as an NLs interface.

The LMF can configure a UE using the Long-Term Evolution (LTE) positioning protocol (LPP) via an AMF in order to facilitate data transfers between the UE and the LMF. A RAN can configure a UE using a radio resource control (RRC) protocol over a LTE-Uu interface and/or a New Radio (NR) interface (i.e., the NR-Uu interface). With Next Generation RAN (NG-RAN), a new NR Positioning Protocol (NRPPa) can be used for transmitting positioning information between the NG-RAN and the LMF over a NG-C interface. These new functions are the basis for positioning support within the 5G network.

The deployment of an LMF by operators is a time-consuming process and likely to occur after the initial deployment of a 5G Core (5GC) network. This is primarily due to the necessity for new interfaces and configuration protocols, which come at a high financial cost. Operators are presently focused on deploying NR and the 5GC network. Given the priority of building a user base for the 5G network, the deployment of additional functions such as providing an LMF in a 5G network deployment is therefore unlikely in the near term. In such a scenario where an LMF is not deployed for a 5G network, it is not possible to meet Location Service (LCS) requirements, which results in unavailability of location information to LCS clients when UEs are connected to the 5G network.

Embodiments herein provide an approach that enables LCS clients to obtain the location of UEs in spite of a 5G network not supporting location services. In accordance with embodiments herein, when an LCS client sends a location request for a given UE, the network can move the UE temporarily to a 3GPP Fourth Generation (4G)/LTE network so that a Serving Mobile Location Center (SMLC) or Mobility Management Entity (MME) can perform location estimates for the UE. After location estimates are provided to the LCS clients, the UE is moved back to the 5G/NR network. If a UE is in an idle state, then this method can be used without causing any impact. However, in the case that a UE is not idle, the UE's Packet Data Unit (PDU) session can be temporarily moved to 4G/LTE to support any necessary network operations.

Thus, the embodiments presented herein provide an improved approach to location support for networks in which location services are otherwise unsupported. This provides the practical application of enabling any LCS clients to obtain location information for user equipment when such operations would otherwise be limited.

It should be noted that references throughout this specification to features, advantages, or similar language herein do not imply that all of the features and advantages that may be realized with the embodiments disclosed herein should be, or are in, any single embodiment. Rather, language referring to the features and advantages is understood to mean that a specific feature, advantage, or characteristic described in connection with an embodiment is included in at least one embodiment. Thus, discussion of the features, advantages, and similar language, throughout this specification may, but do not necessarily, refer to the same embodiment.

Furthermore, the described features, advantages, and characteristics may be combined in any suitable manner in one or more embodiments. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages will become more fully apparent from the following drawings, description and appended claims, or may be learned by the practice of embodiments as set forth hereinafter.

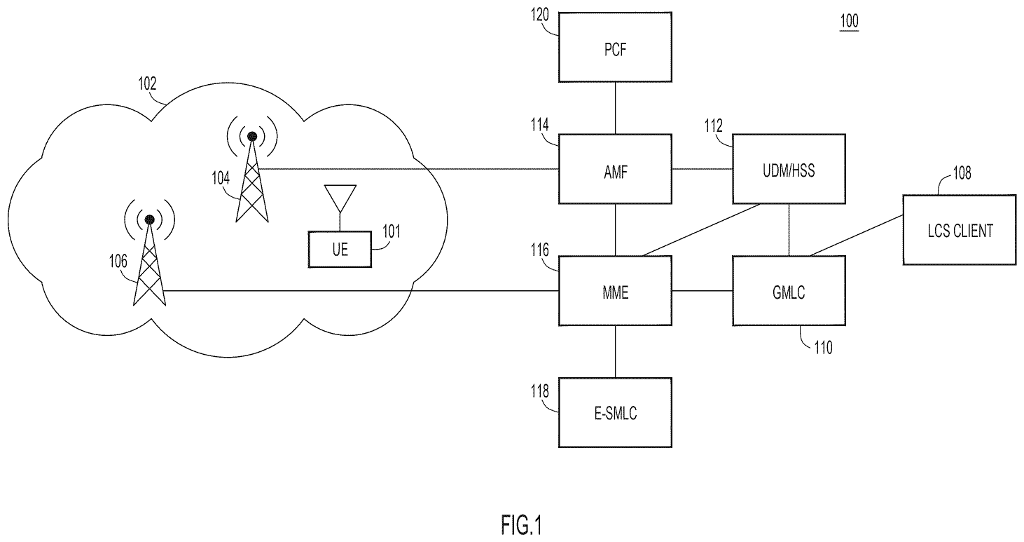

Embodiments will now be described in detail with reference to the Figures. Reference is now made to FIG. 1. FIG. 1 depicts an environment 100 for performing evolved packet system (EPS) fallback to support location services when a UE is connected to a 5G network, according to an example embodiment. As depicted, environment 100 includes a radio access network (RAN) 102 that includes user equipment (UE) 101 and radio base stations 104 and 106. Also include in environment 100 is an LCS client 108, a Gateway Mobile Location Center (GMLC) 110, a Unified Data Management (UDM) entity and/or Home Subscriber Server (HSS) 112, an AMF 114, an MME 116, an Evolved Serving Mobile Location Center (E-SMLC) 118, and a Policy Control Function (PCF) 120. Radio base station 104 may correspond to a gNodeB (gNB), and radio base station 106 may correspond to an eNodeB (eNB). Environment 100 depicts a mixed 4G/LTE and 5G network and can support connectivity for UEs using either 4G/LTE functions or 5G functions. In the depicted example, radio base station 104 (a gNodeB), AMF 114, PCF 120, and the UDM function of UDM/HSS 112 are considered to be 5G network elements, and radio base station 106 (an eNodeB) and MME 116 are considered to be 4G/LTE network elements.

No LMF is shown for environment 100 as the 5G network does not support determining UE location using a 5G LMF.

UE 101 may include any wireless electronic device that initiates a connection or communication session with a wireless network (e.g., RAN 102), and may be inclusive of but not limited to a computer, a mobile phone or mobile communication device, an electronic tablet, a laptop, etc., an electronic device such as an industrial device (e.g., a robot), automation device, enterprise device, appliance, Internet of Things (IoT) device, a router or gateway with a wireless interface, a wireless enabled device, and/or any other device, component, element, or object capable of initiating voice, audio, video, media, or data exchanges within a system. Thus, a wireless device may include any hardware and/or software to perform baseband signal processing (such as modulation/demodulation) as well as hardware (e.g., baseband processors (modems), transmitters and receivers, transceivers, and/or the like), software, logic and/or the like to facilitate signal transmissions and signal receptions via antenna assemblies (not shown) in order to connect to one or more radio nodes of one or more wireless networks, such as radio base stations 104 and/or 106 of RAN 102. UE 101 may be configured to connect to both 5G networks and 4G/LTE networks. Thus, in RAN 102, UE 101 can connect to a gNB (e.g., radio base station 104) for 5G network services or UE 101 can connect to an eNB (e.g., radio base station 106) for 4G/LTE network services.

Any network functions can be employed in environment 100; as depicted, the network functions include GMLC 110, UDM/HSS 112, AMF 114, MME 116, E-SMLC 118, and PCF 120. GMLC 110 is a network entity in a 5G Core Network that supports Location Services (LCS), which can determine the location of UEs when a 5G network is fully implemented. However, in the depicted embodiment, no LMF is deployed and thus, environment 100 does not support determining UE locations via the 5G network functions. Thus, EPS fallback can be performed in environment 100 in order to determine the location of UEs using the preexisting 4G architecture. GMLC 110 may be a combined EPC GMLC and 5GC GMLC that interfaces with both the MME 116 and the AMF 114.

UDM/HSS 112 may include functions for storing and managing network user data. Generally, a UDM performs these operations in a 5G network, whereas an HSS is the 4G/LTE analog. Thus, UDM/HSS 112 may represent either or both of these network functions in environment 100. UDM/HSS 112 can be paired with a user data repository that stores user data such as customer profile information, customer authentication information, encryption keys, and the like. UDM/HSS 112 may reside on the control plane and utilize microservices to communicate between the user plane and control plane. UDM/HSS 112 may authenticate a UCS client to authorize the UCS client to perform location requests with regard to particular UEs in accordance with the embodiments presented herein.

AMF 114 and MME 116 are network functions that perform operations such as UE registration management, connection management (e.g., establishing control plane connections with UEs), reachability management, mobility management (e.g., maintaining knowledge of UE locations within a network), access authentication, and the like. AMF 114 may support these operations in a 5G network, whereas MME 116 may support these operations in a 4G/LTE network.

E-SMLC 118 is a 4G network function that is configured to determine the network-based locations of UEs. E-SMLC may include one or more Location Measurement Units (LMUs) that measure radio signals to identify UEs, whose locations can be determined using triangulation or other techniques such as a Timing Advance (TA) method. E-SMLC 118 may communicate with GMLC 110, which acts as an interface to LCS clients (e.g., LCS client 108).

PCF 120 is a network function for 5G networks that is analogous to a Policy and Charging Rules Function (PCRF) in 4G/LTE networks. PCF 120 is configured to implement end-to-end policy management, to define policies for various network slices, to enable service exposure to external applications, and other operations that generally govern network behavior. PCF 120 can utilize policy subscription information stored in a User Data Repository to provide policy rules to other network functions (e.g., the AMF). PCF 120 may use a representation state transfer (REST) based interface to integrate with AMF 114 for access and mobility policies and to a session management function (SMF, not shown in FIG. 1) for session management policies.

LCS client 108 may include any hardware and/or software entity that makes requests for location information of one or more target UEs. LCS client 108 may place requests for location information to an LCS server, such as GMLC 110. LCS client 108 may be authenticated by an LCS server in order to receive location information.

As both 4G/LTE and 5G network operations are supported in environment 100, EPS fallback can be performed to hand over UEs from the 5G network to the 4G/LTE network. In the depicted embodiment, location services are not supported by the 5G network, so environment 100 is configured to cause a UE to fallback from the 5G network to the 4G/LTE network when an LCS client requests the location of the UE. In particular, a UE can be caused to fall back temporarily so that location services can be supported using the preexisting 4G infrastructure, after which the connection of the UE to the 5G network can be restored by the MME 116 causing the UE to move back to the 5G network.

During operation of environment 100, LCS client 108 may transmit a Location Request for a target UE (e.g., UE 101) to GMLC 110. LCS client 108 may communicate with GMLC 110 via an Le interface. In at least one embodiment, once GMLC 110 receives the request, GMLC 110 determines that the UE is within NR coverage/connected to the 5G network and that location services are not supported by the 5G network. GMLC 110 communicates with UDM/HSS 112 to obtain the identity of the AMF (e.g., AMF 114) to which the UE is associated. In some embodiments, GMLC 110 communicates with the AMF (e.g., AMF 114) by sending a location request, and the AMF provides a reply that indicates that there is no location support (e.g., no LMF in the 5G network). In other embodiments, GMLC 110 may be previously configured with the knowledge that location services are not supported in environment 100.

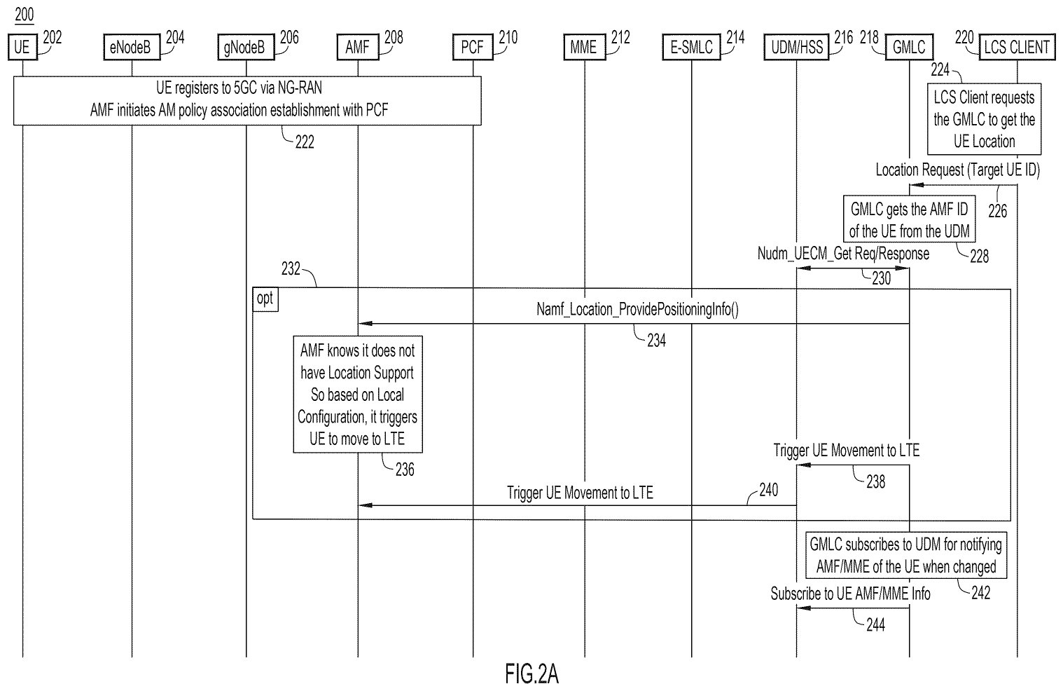

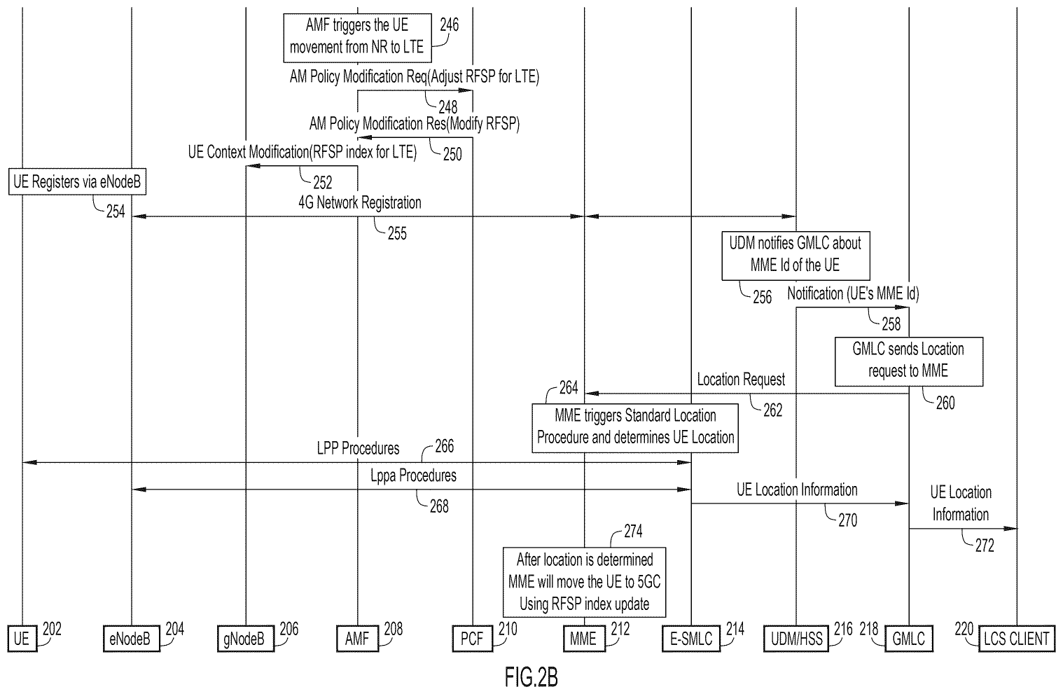

Upon either being triggered to provide location information for the UE (see operation 234, which is depicted and described with reference to FIG. 2A) or being triggered to move the UE to the 4G network (see operation 240, which is also depicted and described with reference to FIG. 2A) the AMF triggers the UE to move from the 5G/NR network to the 4G/LTE network. The AMF can trigger the UE movement/fallback to the 4G/LTE network by causing a Radio Access Technology (RAT)/Frequency Selection Priority (RFSP) index for LTE to be sent to the UE. Current 3GPP standards provide for dynamic Access Management (AM) policies that may be utilized by the core network to cause a UE to latch onto a particular Radio Access Technology (RAT) type by providing a RFSP value or index for the particular RAT type to the UE. For example, a 3GPP 5G radio node, such as a gNodeB, can make use of an RFSP index for radio resource management such that the mobile core network or, more specifically a mobility management node within the mobile core network, such as an Access and Mobility Management Function (AMF), can use the RFSP index for a particular RAT type to direct the UE to latch on to/connect to the particular RAT type through dynamically updating an AM policy for the UE for various reasons, such as network congestion, coverage issues, etc.

Upon receiving the RFSP index for LTE, the UE is caused to handover/latch onto and register with the 4G/LTE network. Information can be communicated from AMF 114 to MME 116 via an N26 interface to enable the handover. The UDM/HSS 112 can notify the GMLC regarding the ID of the MME 116 with which the UE 101 is registered for the 4G/LTE network.

After receiving the RFSP index, the UE 101 can register with an eNodeB (e.g., radio base station 106), and the HSS function of UDM/HSS 112 can provide GMLC 110 with the identity of the MME (e.g., MME 116) to which the UE 101 is associated., GMLC 110 indicates a location request to the MME (e.g., MME 116). Using 4G location procedures, the location of UE 101 is determined and provided to GMLC 110. In particular, MME 116 can receive the location information and forward the location information to GMLC 110. The location of UE 101 can be determined by MME 116 accessing E-SMLC 118 via an SLs interface, and MME 116 can provide the location information to GMLC 110 via an SLg interface. In turn, GMLC 110 provides the location to LCS client 108 over the LE interface. After determining the location, UE 101 can be moved back to NR Coverage via another RFSP index update. In some embodiments, there is a timer associated with the RFSP index update, and once the timer elapses, the RFSP index is updated to cause the UE 101 to move back to the 5G network. The timer may be managed by MME 116.

FIGS. 2A and 2B are a signaling flow diagram depicting a method 200 for supporting location services using EPS fallback when a UE is connected to a 5G network, according to an example embodiment. As depicted, method 200 involves various hardware and/or software entities, including a UE 202, an eNodeB 204, a gNodeB 206, an AMF 208, a PCF 210, a MME 212, an E-SMLC 214, a UDM/HSS 216, a GMLC 218, and an LCS client 220, which can be implemented by the hardware and/or software entities of the same names that are depicted and described with reference to FIG. 1.

With reference to FIG. 2A, UE 202 registers to a 5GC network via the gNodeB 206 NG-RAN at operation 222. AMF 208 can initiate an access and mobility (AM) policy association that is established with PCF 210. Thus, UE 202 can perform operations via the 5G network until a location request is placed by LCS client 220 (operation 224), as the 5G network in this example embodiment does not support location services. At operation 226, LCS client 220 transmits a request to GMLC 218 to obtain the location of UE 202. The request can include an identifier of the target UE (e.g., a UE ID). Using the UE ID, GMLC 218 determines the identifier of the AMF 208 with which UE 202 is associated at operation 228. This information can be obtained by accessing the UDM function of UDM/HSS 216. GMLC 218 communicates with UDM/HSS 216 to obtain this information via a request and response transaction at operation 230.

Operation set 232 involves different operational variations in which different network elements can be used to determine that location services are not supported by the 5G network, triggering the movement of UE 202 to an 4G/LTE network. For a first option (in which the GMLC is not configured to be aware that LCS is not supported by 5G) At operation 234, GMLC 218 transmits a request to the identified AMF 208 to provide the positioning information for UE 202. At operation 236, AMF 208 determines that location services are not supported by the 5G network, and based on the local configuration, triggers the movement of UE 202 to 4G/LTE.

For a second option (in which the GMLC is configured to be aware that LCS is not supported by 5G), GMLC 218 can transmit a request to UDM/HSS 216 to trigger the UE movement at operation 238, and in turn, UDM/HSS 216 can forward the request to AMF 208 at operation 240.

At operation 242, GMLC 218 subscribes to UDM/HSS 216 to obtain information from the AMF 208 and/or MME 212 to which UE 202 is, or may become, associated. A request is placed by GMLC 218 at operation 244 to UDM/HSS 216 to subscribe to the AMF/MME information for UE 202.

The description of method 200 continues now with reference to FIG. 2B. At operation 246, AMF 208 triggers the movement of UE 202 from NR to LTE. First, a request is transmitted to PCF 210 by AMF 208 at operation 248 to adjust the RFSP index values for UE 202 to move UE 202 to LTE. PCF 210 may transmit a confirmation response regarding the FSP index change at operation 250. Next, at operation 252, AMF 208 can transmit the updated RFSP index to gNodeB 206 and then to UE 202 so that UE 202 is caused to be disconnected from the 5G network and caused to be connected to the 4G/LTE network, which includes the UE 202 performing a registration with the 4G network via eNodeB 204, as shown at operation 254. At operation 255, 4G network registration is performed for the UE 202 by the eNodeB 204 communicating the registration request to MME 212, which then updates the UDM/HSS 216 with regard to the 4G status of UE 202. Now that UE 202 is connected to eNodeB 204, the movement to LTE is completed by UDM/HSS 216 notifying GMLC 218 about the MME ID of UE 202 at operation 256, which is transmitted at operation 258 to GMLC 218.

At operation 260, GMLC 218 determines to send a location request to MME 212 for the location of UE 202, and the request is transmitted at operation 262. MME 212 triggers a location procedure to determine the location of UE 202 at operation 264, and LTE Positioning Protocol (LPP) procedures are performed between E-SMLC 214 and UE 202 at operation 266. The LPPa protocol can be utilized for communications between E-SMLC 214 and eNodeB 204, to which UE 202 is now connected, at operation 268. Thus, the location information is obtained for UE 202. This location information is forwarded from MME 212 to GMLC 218 at operation 270, and again forwarded from GMLC 218 to LCS client 220 at operation 272.

Thus, LCS client 220 may receive the location information for UE 202 via location determination/estimation operations performed by the E-SMLC 214 and the MME 212 of the 4G/LTE infrastructure. At operation 274, MME 212 can perform an RESP index update to move UE 202 back to the 5GC network at operation 274. MME 212 may provide the RFSP index to UE 202 to cause UE 202 to move back to the 5GC network. In some embodiments, the movement of UE 202 back to a 5GC network may be performed in response to obtaining the location information. In other embodiments, the RFSP index may be updated after a predetermined amount of time in order to move UE 202 back to 5G. Method 200 may be performed according to a predetermined schedule when UE 202 is determined to be idle in order to obtain location information for UE 202 at times other than in response to a location request by an LCS client. Thus, the location information obtained when UE 202 is idle can be used to estimate a recent location of UE 202 without interrupting service when UE 202 is in use. For example, method 200 can be performed when UE 202 is determined to enter an idle state, or every five minutes during an idle period, etc.

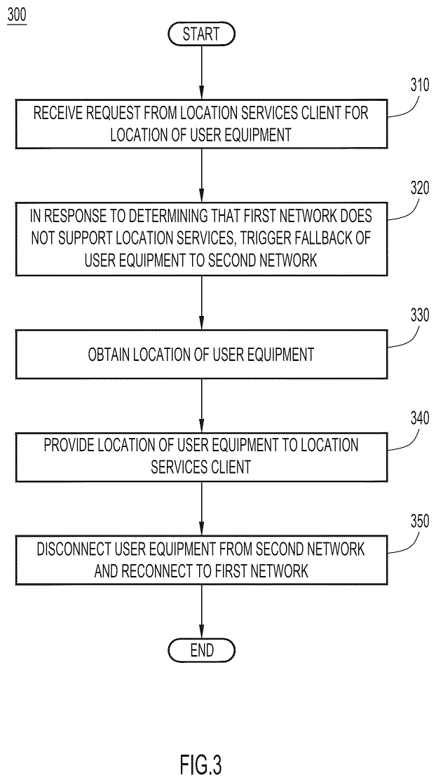

FIG. 3 is a flow chart depicting a method 300 for supporting location services using EPS fallback, according to an example embodiment.

A request is received from a location services client for the location of a user equipment at operation 310. The location services client can be a software application or hardware device that is associated with user equipment or a remote server. In order to perform desired operations, the location services client may require the location the user equipment. The request for location information may be received by a GMLC, which communicates with an AMF to determine that location services are not supported by the 5G network.

In response to determining that a first network (e.g., a 5G network) does not support location services, a fallback of the user equipment to a second network (e.g., a 4G/LTE network) is triggered at operation 320. The fallback occurs by updating an RFSP index to indicate that the user equipment should be connected to a 4G network. Thus, the UE registers with an eNodeB and establishes a connection to the 4G network.

The location of the user equipment is obtained at operation 330. Using a location protocol such as LPPa, the SMLC can communicate with the eNodeB to which the user equipment is connected in order to obtain location information regarding the user equipment. The location of the user equipment is provided to the location services client at operation 340. The location information can be forwarded from an MME to the GMLC, which can provide the LCS client with the location information. Thus, a response to the location services request may be successfully completed.

The user equipment is disconnected from the second network and reconnected to the first network at operation 350. The user equipment may be reconnected to the first network (e.g., the 5G network) by updating an RFSP index entry regarding the user equipment. In some embodiments, the RFSP index is updated in response to the location request being satisfied. In other embodiments, the RFSP index may be updated after a predetermined amount of time has elapsed.

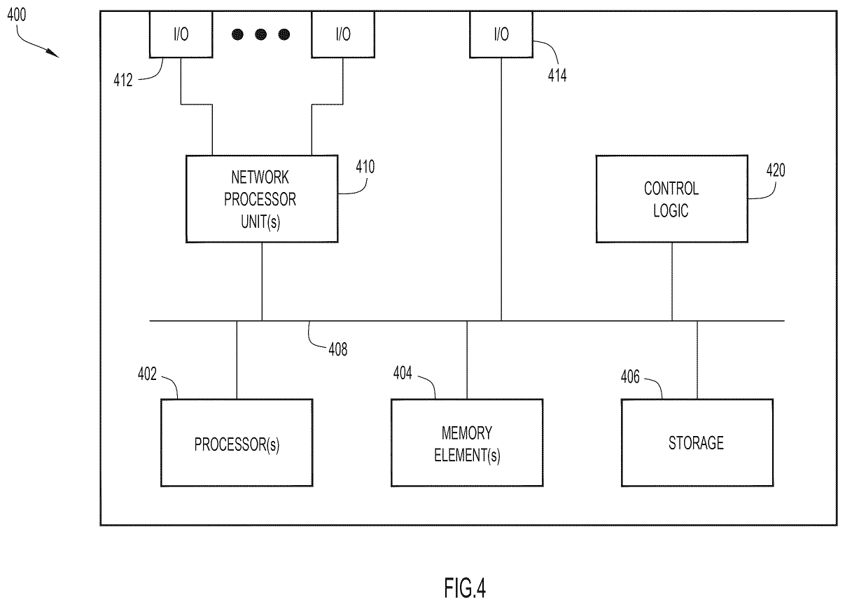

Referring now to FIG. 4, FIG. 4 illustrates a hardware block diagram of a computing device 400 that may perform functions associated with operations discussed herein in connection with the techniques depicted in FIGS. 1-3. In at least one embodiment, the computing device 400 may include one or more processor(s) 402, one or more memory element(s) 404, storage 406, a bus 408, one or more network processor unit(s) 410 interconnected with one or more network input/output (I/O) interface(s) 412, one or more I/O 414, and control logic 420. In various embodiments, instructions associated with logic for computing device 400 can overlap in any manner and are not limited to the specific allocation of instructions and/or operations described herein.

In at least one embodiment, processor(s) 402 is/are at least one hardware processor configured to execute various tasks, operations and/or functions for computing device 400 as described herein according to software and/or instructions configured for computing device 400. Processor(s) 402 (e.g., a hardware processor) can execute any type of instructions associated with data to achieve the operations detailed herein. In one example, processor(s) 402 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 404 and/or storage 406 is/are configured to store data, information, software, and/or instructions associated with computing device 400, and/or logic configured for memory element(s) 404 and/or storage 406. For example, any logic described herein (e.g., control logic 420) can, in various embodiments, be stored for computing device 400 using any combination of memory element(s) 404 and/or storage 406. Note that in some embodiments, storage 406 can be consolidated with memory element(s) 404 (or vice versa), or can overlap/exist in any other suitable manner.

In at least one embodiment, bus 408 can be configured as an interface that enables one or more elements of computing device 400 to communicate in order to exchange information and/or data. Bus 408 can be implemented with any architecture designed for passing control, data and/or information between processors, memory elements/storage, peripheral devices, and/or any other hardware and/or software components that may be configured for computing device 400. In at least one embodiment, bus 408 may be implemented as a fast kernel-hosted interconnect, potentially using shared memory between processes (e.g., logic), which can enable efficient communication paths between the processes.

In various embodiments, network processor unit(s) 410 may enable communication between computing device 400 and other systems, entities, etc., via network I/O interface(s) 412 (wired and/or wireless) to facilitate operations discussed for various embodiments described herein. In various embodiments, network processor unit(s) 410 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 400 and other systems, entities, etc. to facilitate operations for various embodiments described herein. In various embodiments, network I/O interface(s) 412 can be configured as one or more Ethernet port(s), Fibre Channel ports, any other I/O port(s), and/or antenna(s)/antenna array(s) now known or hereafter developed. Thus, the network processor unit(s) 410 and/or network I/O interface(s) 412 may include suitable interfaces for receiving, transmitting, and/or otherwise communicating data and/or information in a network environment.

I/O 414 allow for input and output of data and/or information with other entities that may be connected to computing device 400. For example, I/O 414 may provide a connection to external devices such as a keyboard, keypad, mouse, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 420 can include instructions that, when executed, cause processor(s) 402 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 420) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 404 and/or storage 406 can store data, software, code, instructions (e.g., processor instructions), logic, parameters, combinations thereof, and/or the like used for operations described herein. This includes memory element(s) 404 and/or storage 406 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

In general, per-3GPP standards for a mobile core network, an AMF interfaces with a SMF which can further interface with one or more UPFs. An AMF and an SMF can further interface with PCF, a UDM/UDR, and various other core network functions via 3GPP Service-Based Interface (SBI) constructs/interfaces and/or any other 3GPP interfaces/reference points. An AMF and a UPF can further interface with a RAN node, such as one or more gNBs or disaggregated components thereof.

A wireless device may be considered any electronic device, etc. that initiates a connection or communication session with a corresponding core network, and may be inclusive of but not limited to a computer, a mobile phone or mobile communication device, an electronic tablet, a laptop, etc., an electronic device such as an industrial device (e.g., a robot), automation device, enterprise device, appliance, Internet of Things (IoT) device, and/or any other device, component, element, or object capable of initiating voice, audio, video, media, or data exchanges within a system. Thus, a wireless device may include any hardware and/or software to perform baseband signal processing (such as modulation/demodulation) as well as hardware (e.g., baseband processors (modems), transmitters and receivers, transceivers, and/or the like), software, logic and/or the like to facilitate signal transmissions and signal receptions via antenna assemblies (not shown) in order to connect to one or more radio nodes of one or more RAN(s).

Generally, an AMF may facilitate access and mobility management control/services for one or more wireless devices seeking connection to/connected to a mobile core network. Generally, an SMF may be responsible for wireless device session management, with individual functions/services being supported on a per-session basis in order to facilitate data transfer(s) between a wireless device and one or more networks via one or more UPFs. Generally, a UPF may operate to provide packet routing and forwarding operations for user data traffic and may also perform a variety of functions such as packet inspection, traffic optimization, Quality of Service (QoS), policy enforcement and user data traffic handling (e.g., to/from one or more data networks), billing operations (e.g., accounting, etc.), among other operations, for wireless device sessions. Typically, a UDM stores subscription data (typically in combination with a UDR) for subscribers (e.g., a user that may be associated with a given wireless device) that can be retrieved and/or otherwise obtained/utilized during operation of a core network system. Typically, a PCF stores policy data in order to provide policy control services (e.g., to facilitate access control for one or more devices, network selection, etc.). Typically, a charging function (CHF) provides support for charging services such as facilitating the transfer of policy counter information associated with subscriber spending limits, etc.

In general, authentication services may include authenticating and/or authorizing one or more device(s) for one or more connections and/or communications and may be inclusive of any Authentication, Authorization, and Accounting (AAA) services that may be facilitated via any combination of authentication/authorization protocols such as Remote Authentication Dial-In User Service (RADIUS), DIAMETER, Extensible Authentication Protocol (EAP) [including any EAP variations], and/or the like. Generally, authentication refers to a process in which an entity's identity is authenticated, typically by providing evidence that it holds a specific digital identity such as an identifier/identity and corresponding credentials/authentication attributes/etc. Generally, authorization can be used to determine whether a particular entity is authorized to perform a given activity.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 602.11 (e.g., Wi-Fi®/Wi-Fi6®), IEEE 602.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In some aspects, the techniques described herein relate to a method including: receiving a request from a location service client for a location of a user equipment that is connected to a first network; in response to determining that the first network does not support location services, triggering a fallback of the user equipment to a second network; obtaining a location of the user equipment using the second network; and providing the location of the user equipment to the location service client.

In some aspects, the techniques described herein relate to a method, wherein a Gateway Mobile Location Center determines to trigger the fallback of the user equipment to the second network in response to determining that the first network does not support location services.

In some aspects, the techniques described herein relate to a method, wherein the Gateway Mobile Location Center receives data from an Access and Mobility Management Function that indicates that the first network does not support location services.

In some aspects, the techniques described herein relate to a method, wherein an identifier of the Access and Mobility Management Function is provided to the Gateway Mobile Location Center via a Unified Data Management service.

In some aspects, the techniques described herein relate to a method, wherein an Access and Mobility Management Function triggers the fallback of the user equipment from the first network to the second network.

In some aspects, the techniques described herein relate to a method, further including: updating a Radio Access Technology (RAT)/Frequency Selection Priority (RFSP) index to cause the user equipment to perform the fallback from the first network to the second network.

In some aspects, the techniques described herein relate to a method, wherein the location of the user equipment is requested from a Mobility Management Entity of the second network.

In some aspects, the techniques described herein relate to a method, further including: in response to obtaining the location of the user equipment; disconnecting the user equipment from the second network and causing the user equipment to connect to the first network.

In some aspects, the techniques described herein relate to a method, further including: disconnecting the user equipment from the second network and causing the user equipment to connect to the first network after a predetermined amount of time.

In some aspects, the techniques described herein relate to a method, wherein the first network is a Third Generation Partnership Project (3GPP) Fifth Generation network and the second network is a 3GPP 4G network.

In some aspects, the techniques described herein relate to a system including: one or more computer processors; one or more computer readable storage media; and program instructions stored on the one or more computer readable storage media for execution by at least one of the one or more computer processors, the program instructions including instructions to: receive a request from a location service client for a location of a user equipment that is connected to a first network; in response to determining that the first network does not support location services, trigger a fallback of the user equipment to a second network; obtain a location of the user equipment using the second network; and provide the location of the user equipment to the location service client.

In some aspects, the techniques described herein relate to a system, wherein a Gateway Mobile Location Center determines to trigger the fallback of the user equipment to the second network in response to determining that the first network does not support location services.

In some aspects, the techniques described herein relate to a system, wherein the Gateway Mobile Location Center receives data from an Access and Mobility Management Function that indicates that the first network does not support location services.

In some aspects, the techniques described herein relate to a system, wherein an identifier of the Access and Mobility Management Function is provided to the Gateway Mobile Location Center via a Unified Data Management service.

In some aspects, the techniques described herein relate to a system, wherein an Access and Mobility Management Function triggers the fallback of the user equipment from the first network to the second network.

In some aspects, the techniques described herein relate to a system, wherein the program instructions further include instructions to: update an RFSP index to cause the user equipment to perform the fallback from the first network to the second network.

In some aspects, the techniques described herein relate to one or more non-transitory computer readable storage media having program instructions embodied therewith, the program instructions executable by a computer to cause the computer to perform operations including: receiving a request from a location service client for a location of a user equipment that is connected to a first network; in response to determining that the first network does not support location services, triggering a fallback of the user equipment to a second network; obtaining a location of the user equipment using the second network; and providing the location of the user equipment to the location service client.

In some aspects, the techniques described herein relate to one or more non-transitory computer readable storage media, wherein a Gateway Mobile Location Center determines to trigger the fallback of the user equipment to the second network in response to determining that the first network does not support location services.

In some aspects, the techniques described herein relate to one or more non-transitory computer readable storage media, wherein the Gateway Mobile Location Center receives data from an Access and Mobility Management Function that indicates that the first network does not support location services.

In some aspects, the techniques described herein relate to one or more non-transitory computer readable storage media, wherein the program instructions further cause the computer to: update an RFSP index to cause the user equipment to perform the fallback from the first network to the second network.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
receiving a request from a location service client for a location of a user equipment that is connected to a first network;
in response to determining that the first network does not support location services, triggering a fallback of the user equipment to a second network;
obtaining a location of the user equipment using the second network; and
providing the location of the user equipment to the location service client.

2. The method of claim 1, wherein a Gateway Mobile Location Center determines to trigger the fallback of the user equipment to the second network in response to determining that the first network does not support location services.

3. The method of claim 2, wherein the Gateway Mobile Location Center receives data from an Access and Mobility Management Function that indicates that the first network does not support location services.

4. The method of claim 3, wherein an identifier of the Access and Mobility Management Function is provided to the Gateway Mobile Location Center via a Unified Data Management service.

5. The method of claim 1, wherein an Access and Mobility Management Function triggers the fallback of the user equipment from the first network to the second network.

6. The method of claim 1, further comprising:
updating a Radio Access Technology (RAT)/Frequency Selection Priority (RFSP) index to cause the user equipment to perform the fallback from the first network to the second network.

7. The method of claim 1, wherein the location of the user equipment is requested from a Mobility Management Entity of the second network.

8. The method of claim 1, further comprising:
in response to obtaining the location of the user equipment; disconnecting the user equipment from the second network and causing the user equipment to connect to the first network.

9. The method of claim 1, further comprising:
disconnecting the user equipment from the second network and causing the user equipment to connect to the first network after a predetermined amount of time.

10. The method of claim 1, wherein the first network is a Third Generation Partnership Project (3GPP) Fifth Generation network and the second network is a 3GPP 4G network.

11. A system comprising:
one or more computer processors;
one or more computer readable storage media; and
program instructions stored on the one or more computer readable storage media for execution by at least one of the one or more computer processors, the program instructions comprising instructions to:
receive a request from a location service client for a location of a user equipment that is connected to a first network;
in response to determining that the first network does not support location services, trigger a fallback of the user equipment to a second network;
obtain a location of the user equipment using the second network; and
provide the location of the user equipment to the location service client.

12. The system of claim 11, wherein a Gateway Mobile Location Center determines to trigger the fallback of the user equipment to the second network in response to determining that the first network does not support location services.

13. The system of claim 12, wherein the Gateway Mobile Location Center receives data from an Access and Mobility Management Function that indicates that the first network does not support location services.

14. The system of claim 13, wherein an identifier of the Access and Mobility Management Function is provided to the Gateway Mobile Location Center via a Unified Data Management service.

15. The system of claim 11, wherein an Access and Mobility Management Function triggers the fallback of the user equipment from the first network to the second network.

16. The system of claim 11, wherein the program instructions further comprise instructions to:
update an RFSP index to cause the user equipment to perform the fallback from the first network to the second network.

17. One or more non-transitory computer readable storage media having program instructions embodied therewith, the program instructions executable by a computer to cause the computer to perform operations including:
receiving a request from a location service client for a location of a user equipment that is connected to a first network;
in response to determining that the first network does not support location services, triggering a fallback of the user equipment to a second network;
obtaining a location of the user equipment using the second network; and
providing the location of the user equipment to the location service client.

18. The one or more non-transitory computer readable storage media of claim 17, wherein a Gateway Mobile Location Center determines to trigger the fallback of the user equipment to the second network in response to determining that the first network does not support location services.

19. The one or more non-transitory computer readable storage media of claim 18, wherein the Gateway Mobile Location Center receives data from an Access and Mobility Management Function that indicates that the first network does not support location services.

20. The one or more non-transitory computer readable storage media of claim 17, wherein the program instructions further cause the computer to:
update an RFSP index to cause the user equipment to perform the fallback from the first network to the second network.
